(19) United States
(12) Patent Application Publication
(10) Pub. No.: US 2004/0242744 A1
(43) Pub. Date: Dec. 2, 2004

(54) Utilization of compositions as internal antistatic agents for thermoplastic synthetic materials

(76) Inventors: Peter Daute, Beverstedt (DE); Ernst-Udo Brand, Bremerhaven (DE)

Correspondence Address: COGNIS CORPORATION, PATENT DEPARTMENT, 300 BROOKSIDE AVENUE, AMBLER, PA, 19002, US

(21) Appl. No.: 10/493,087

(22) PCT Filed: Oct. 10, 2002
(86) PCT No.: PCT/EP02/11331

(30) Foreign Application Priority Data
Oct. 18, 2001 (DE) 10151486.7

(51) Int. Cl. C08L 1/00

(52) U.S. Cl. 524/318

(57) ABSTRACT

Processes for imparting antistatic properties are described, wherein the processes include: (a) providing a one or more partial esters of a C₆₋₂₂ fatty acid with a polyhydric alcohol selected from the group consisting of glycerol and polyglycerol; (b) providing one or more perchlorates; and (c) combining the one or more partial esters and the one or more perchlorates with a plastic compound.

### FIELD OF THE INVENTION

This invention relates to the use of compositions based on partial esters of glycerol and/or polyglycerols and perchlorates as internal antistatic agents for thermoplastics.

### PRIOR ART

Plastics, for example polyethylene, polypropylene and PVC, are pronounced nonconductors, i.e. high-quality electrical insulators. The effect of this property is that the surface is electrically charged so that moldings are soiled and become unsightly through the resulting attraction of dust. These unfavorable properties can largely be prevented by antistatic agents.

There are external and internal antistatic agents. External antistatic agents are products which are applied as a thin layer to the surface of plastic moldings. The disadvantage of this surface coating lies in the lack of durability of the antistatic effect so that the protective effect gradually weakens and an aftertreatment has to be applied, above all after rinsing and washing. Internal antistatic agents are part of the plastic compound and are incorporated in the plastic together with other additives. The major advantage of internal antistatic agents is the permanence of their effect.

### DESCRIPTION OF THE INVENTION

The problem addressed by the present invention was to provide compositions which would be suitable for the antistatic finishing of organic thermoplastics, more particularly polyethylenes, polypropylenes, polycarbonates and polyvinyl chloride without adversely affecting the performance properties of the plastics. For PVC in particular, the compositions to be provided by the invention would not have any adverse effects in terms of thermal and/or photochemically induced degradation of the plastic.

The present invention relates to the use of compositions as internal antistatic agents for thermoplastics, the compositions containing:

A) 80 to 99.99% by weight of one or more partial esters of C₆₋₂₂ fatty acids with polyhydric alcohols selected from the group of glycerol and polyglycerols and

B) 0.01 to 20% by weight of one or more perchlorates.

The compounds A) are partial esters of C₆₋₂₂ fatty acids with polyhydric alcohols selected from the group of glycerol and polyglycerols.

The fatty acids on which the compounds A) are based may be saturated or unsaturated, linear or branched. Examples of suitable fatty acids are hexanoic acid, heptanoic acid, octanoic acid, 2-ethylhexanoic acid, decanoic acid, lauric acid, tridecanoic acid, myristic acid, pentadecanoic acid, palmitic acid, heptadecanoic acid, stearic acid, 12-hydroxystearic acid, nonadecanoic acid, arachic acid, heneicosanoic acid, behenic acid, 10-undecenoic acid, lauroleic acid, myristoleic acid, palmitoleic acid, oleic acid, petroselic acid, elaidic acid, ricinoleic acid, linoleic acid, linolaidic acid, linolenic acid, elaeostearic acid, gadoleic acid, arachidonic acid, erucic acid, brassidic acid, clupanodonic acid.

Polyglycerols in the context of the invention are oligomerization products of glycerol. The degree of oligomerization of the polyglycerols is between 2 and 20. They are characterized by the following general formula:

HO—CH₂—CH₂OH—CH₂—(O—CH₂—CH₂OH—CH₂)ₙ—OH (I)

where n is a number of 1 to 19.

Polyglycerols are commercially available compounds. They may be produced from epichlorohydrin or glycerol by methods known to the expert.

The compounds A) may be obtained, for example, by reacting C₆₋₂₂ fatty acids with glycerol or polyglycerols. The reaction conditions are selected so that, on average, the polyhydric alcohols used are merely partly esterified. This means that the reaction products contain on average at least one free, i.e. nonesterified, OH group per molecule.

Basically, there are no limitations with respect to the thermoplastics. However, thermoplastics selected from the group consisting of polyethylenes, polypropylenes, polyethylene terephthalate (PET), polycarbonates and polyvinyl chloride are preferred.

Perchlorates (B) in the context of the invention are metal salts and ammonium salts of perchloric acid. Examples of perchlorates suitable for the purposes of the invention are those with the formula M(ClO₄)ₙ, where M stands in particular for ammonium, Li, Na, K, Mg, Ca, Sr, Zn, Al, La or Ce. The index n is 1, 2 or 3 according to the valency of the cation M.

The perchlorate salts may be complexed with or dissolved in alcohols, for example polyols, cyclodextrins or ether alcohols or ester alcohols. The ester alcohols also include the polyol partial esters. In the case of polyhydric alcohols or polyols, dimers, trimers, oligomers and polymers thereof, such as di-, tri-, tetra- and polyglycols and di-, tri- and tetrapentaerythritol, or polyvinyl alcohol in various degrees of polymerization may also be used. So far as perchlorate/alcohol complexes are concerned, the types to the expert known from EP-B-394 547, page 3, lines 37 to 56 are specifically included.

The perchlorate salts may be used in various typical supply forms, for example as a salt or solution in water or an organic solvent as such or absorbed onto a carrier material, such as PVC, Ca silicate, zeolites or hydrotalcites, or bound by chemical reaction into a hydrotalcite or other layer lattice compound. Preferred polyol partial ethers are glycerol monoether and glycerol monothioether.

The perchlorates may be used individually or in admixture with one another.

The compositions to be used in accordance with the invention may advantageously be incorporated in thermoplastics to be antistatically finished by the following methods:

as an emulsion or dispersion (One possibility is, for example, a paste-form mixture. An advantage of the combination according to the invention in this supply form is the stability of the paste);

as a dry mixture during the mixing of added components or polymer mixtures;

by direct introduction into the processing machine (for example calender, mixer, kneader, extruder or the like) or

as a solution or melt.

The thermoplastic finished with the compositions according to the invention contains the compounds (B) in a quantity of 0.001 to 1.0 phr and more particularly in a quantity of 0.002 to 0.5 phr, the ratio by weight of compounds (A) to compounds (B) being 1,000:1 to 1,000:200. The abbreviation phr (parts per hundred resin) familiar to the expert indicates the quantity in parts by weight in which the component is present in the PVC (based on 100 parts by weight of PVC).

The thermoplastic antistatically finished in accordance with the invention may be brought into the required form by known methods such as, for example, calendering, extrusion, injection molding, sintering or spinning, extrusion blowing or the plastisol process. The plastisol process, extrusion and calendering are particularly preferred.

### EXAMPLES

### Substances Used

PVC (I): S-PVC (K value 60)

PVC (II): E-PVC (K value 60)

KANE ACE B-58A: impact modifier (Kaneca)

Paraloid K 175: processing aid (Rohm & Haas)

Irgastab 17 MOK: Sn-based PVC stabilizer (Crompton)

Loxiol P 1141: lubricant (Cognis)

Loxiol G 74: lubricant (Cognis)

Triglycerol partial ester: partial ester of commercially available triglycerol (Solvay) and head-fractionated fatty acid (C6=2%, C8=60%, C10=35%, C12=3%); the partial ester is characterized by the following data: hydroxyl value (OHV) 389, saponification value (SV) 202

Diglycerol partial ester: partial ester of commercially available triglycerol (Solvay) and head-fractionated fatty acid (C6=2%, C8=60%, C10=35%, C12=3%); the partial ester is characterized by the following data: hydroxyl value (OHV) 440, saponification value (SV) 207

### Examples E1 and E2

The individual formulation ingredients of the test formulations on the one hand and the test results obtained on the other hand are set out in Table 1 below. The numbers of the respective Examples are shown in the first line of the Table. Examples E1 and E2 are intended for comparison. The quantities of the individual components are expressed in phr (parts per hundred resin) which indicates the quantities in parts by weight in which the particular components are present in the PVC (based on 100 parts by weight PVC) after addition of the composition. Accordingly, the formulations always contain 100 parts S-PVC.

Rolled sheets were produced from the formulations of Table 1. The rolled sheets were produced by mixing the PVC powder and the additives mentioned together and homogenizing and plasticizing the mixture on laboratory mixing rolls for 5 minutes at 180° C. Test specimens measuring 10×10 cm were cut out from the ca. 0.5 mm thick rolled sheets thus produced.

The surface resistivity of the test specimens was determined to DIN 53 482/VDE 0303, Part 3.

TABLE 1

| | E1 | E2 |
|---|---|---|
| PVC (I) | 100 | 100 |
| PVC (II) | 3 | 3 |
| KANE ACE B-58 A | 5 | 5 |
| Paraloid K 175 | 1 | 1 |
| Irgastab 17 MOK | 1.5 | 1.5 |
| Loxiol P 1141 | 0.5 | 0.5 |
| Loxiol G 74 | 0.4 | 0.4 |
| Na perchlorate | — | 0.05 |
| Specific resistivity (ohms) | >10¹⁵ | >10¹⁵ |

### Examples E3 and E4

The individual formulation ingredients of the test formulations on the one hand and the test results obtained on the other hand are set out in Table 2 below. The numbers of the respective Examples are shown in the first line of the Table. Example E3 is intended for comparison, Example E4 corresponds to the invention. The quantities of the individual components are expressed in phr (parts per hundred resin) which indicates the quantities in parts by weight in which the particular components are present in the PVC (based on 100 parts by weight PVC) after addition of the composition. Accordingly, the formulations always contain 100 parts S-PVC.

Rolled sheets were produced from the formulations of Table 2. The rolled sheets were produced by mixing the PVC powder and the additives mentioned together and homogenizing and plasticizing the mixture on laboratory mixing rolls for 5 minutes at 180° C. Test specimens measuring 10×10 cm were cut out from the ca. 0.5 mm thick rolled sheets thus produced.

The surface resistivity of the test specimens was determined to DIN 53 482/VDE 0303, Part 3.

TABLE 2

| | E3 | E4 |
|---|---|---|
| PVC (I) | 100 | 100 |
| PVC (II) | 3 | 3 |
| KANE ACE B-58 A | 5 | 5 |
| Paraloid K 175 | 1 | 1 |
| Irgastab 17 MOK | 1.5 | 1.5 |
| Loxiol P 1141 | 0.5 | 0.5 |
| Loxiol G 74 | 0.4 | 0.4 |
| Triglycerol partial ester | 1 | 1 |
| Na perchlorate | — | 0.05 |
| Specific resistivity (ohms) | >10¹⁴ | >10¹⁰ |

### Examples E5 and E6

The individual formulation ingredients of the test formulations on the one hand and the test results obtained on the other hand are set out in Table 3 below. The numbers of the respective Examples are shown in the first line of the Table. Example E5 is intended for comparison, Example E6 corresponds to the invention. The quantities of the individual components are expressed in phr (parts per hundred resin) which indicates the quantities in parts by weight in which the particular components are present in the PVC (based on 100 parts by weight PVC) after addition of the composition. Accordingly, the formulations always contain 100 parts S-PVC.

Rolled sheets were produced from the formulations of Table 3. The rolled sheets were produced by mixing the PVC powder and the additives mentioned together and homogenizing and plasticizing the mixture on laboratory mixing rolls for 5 minutes at 180° C. Test specimens measuring 10×10 cm were cut out from the ca. 0.5 mm thick rolled sheets thus produced.

The surface resistivity of the test specimens was determined to DIN 53 482/VDE 0303, Part 3.

TABLE 3

| | E5 | E6 |
|---|---|---|
| PVC (I) | 100 | 100 |
| PVC (II) | 3 | 3 |
| KANE ACE B-58 A | 5 | 5 |
| Paraloid K 175 | 1 | 1 |
| Irgastab 17 MOK | 1.5 | 1.5 |
| Loxiol P 1141 | 0.5 | 0.5 |
| Loxiol G 74 | 0.4 | 0.4 |
| Triglycerol partial ester | 1 | 1 |
| Na perchlorate | — | 0.05 |
| Specific resistivity (ohms) | >10¹⁴ | >10¹⁰ |

1-2: (Canceled).

3: A process for imparting antistatic properties, said process comprising:
(a) providing a one or more partial esters of a C₆₋₂₂ fatty acid with a polyhydric alcohol selected from the group consisting of glycerol and polyglycerol;
(b) providing one or more perchlorates; and
(c) combining the one or more partial esters and the one or more perchlorates with a plastic compound.

4: The process according to claim 3, wherein the one or more partial esters is present in an amount of from 80 to 99.99% by weight based on the combined weight of the partial esters and the perchlorates.

5: The process according to claim 3, wherein the one or more perchlorates is present in an amount of from 0.01 to 20% by weight based on the combined weight of the partial esters and the perchlorates.

6: The process according to claim 3, wherein the one or more partial esters is present in an amount of from 80 to 99.99% by weight based on the combined weight of the partial esters and the perchlorates, and wherein the one or more perchlorates is present in an amount of from 0.01 to 20% by weight based on the combined weight of the partial esters and the perchlorates.

7: The process according to claim 3, wherein the C₆₋₂₂ fatty acid comprises a linear fatty acid.

8: The process according to claim 3, wherein the C₆₋₂₂ fatty acid comprises a saturated fatty acid.

9: The process according to claim 3, wherein the C₆₋₂₂ fatty acid comprises a saturated C₆₋₁₂ fatty acid.

10: The process according to claim 3, wherein the C₆₋₂₂ fatty acid comprises a mixture of two or more fatty acids.

11: The process according to claim 3, wherein the C₆₋₂₂ fatty acid comprises a mixture of C₆, C₈, C₁₀ and C₁₂ saturated fatty acids.

12: The process according to claim 3, wherein the polyhydric alcohol comprises a polyglycerol having a degree of polymerization of from 2 to 20.

13: The process according to claim 3, wherein the polyhydric alcohol comprises triglycerol.

14: The process according to claim 10, wherein the polyhydric alcohol comprises a polyglycerol having a degree of polymerization of from 2 to 20.

15: The process according to claim 10, wherein the polyhydric alcohol comprises triglycerol.

16: The process according to claim 3, wherein the one or more perchlorates comprises a perchlorate/alcohol complex.

17: The process according to claim 3, wherein the one or more perchlorates is combined with the plastic compound in an amount of from 0.001 to 1 phr.

18: The process according to claim 17, wherein the weight ratio of the one or more partial esters to the one or more perchlorates is from 1000:1 to 1000:200.

19: The process according to claim 3, wherein the plastic compound is selected from the group consisting of polyethylenes, polypropylenes, polycarbonates, polyethylene terephthalate and polyvinylchloride.

20: A process for imparting antistatic properties, said process comprising:
(a) providing a one or more partial esters of a mixture of two or more C₆₋₂₂ fatty acids with a polyglycerol;
(b) providing one or more perchlorates; and
(c) combining the one or more partial esters and the one or more perchlorates with a plastic compound selected from the group consisting of polyethylenes, polypropylenes, polycarbonates, polyethylene terephthalate and polyvinylchloride; wherein the one or more partial esters is present in an amount of from 80 to 99.99% by weight based on the combined weight of the partial esters and the perchlorates, and wherein the one or more perchlorates is present in an amount of from 0.01 to 20% by weight based on the combined weight of the partial esters and the perchlorates.
